(19) United States
(12) Patent Application Publication
(10) Pub. No.: US 2026/0106268 A1
(43) Pub. Date: Apr. 16, 2026

(54) SEPARATOR STRUCTURES FOR MITIGATING THE TRANSFER OF THERMAL ENERGY INSIDE TRACTION BATTERY PACKS

(71) Applicant: FORD GLOBAL TECHNOLOGIES, LLC, Dearborn, MI (US)

(72) Inventors: Scott M. Rollins, Highland, MI (US); Jacob Stec, Canton, MI (US); Dominic Mario Bertolini, Royal Oak, MI (US); David Doman, Canton, MI (US); Afif Sabbagh, Troy, MI (US); Venkata Krishna Chaitanya Kanaparthi, Novi, MI (US); Francisco Fernandez-Galindo, Canton, MI (US)

(21) Appl. No.: 18/912,224

(22) Filed: Oct. 10, 2024

(51) Int. Cl. H01M 10/658; H01M 50/211; H01M 50/242; H01M 50/249; H01M 50/289; H01M 50/367

(52) U.S. Cl. CPC H01M 10/658; H01M 50/242; H01M 50/249; H01M 50/289; H01M 50/367; H01M 50/211

(57) ABSTRACT

Battery systems are provided for traction battery packs. An exemplary battery system may include a first cell stack, a second cell stack, and a separator arranged between the first and second cell stacks. The separator may be configured to mitigate the transfer of thermal energy from cell stack-to-cell stack, structurally integrate the battery system to perimeter structures, inhibit cell displacement due to external forces, resist cell expansion forces, etc.

### TECHNICAL FIELD

This disclosure relates generally to traction battery packs, and more particularly to battery system structural separators that function to, among other things, mitigate the transfer of thermal energy between adjacent cell stacks of the battery system.

### BACKGROUND

Electrified vehicles include a traction battery pack for powering electric machines and other electrical loads of the vehicle. The traction battery pack includes a plurality of battery cells and various other battery internal components that support electric vehicle propulsion.

### SUMMARY

A battery system for a traction battery pack according to an exemplary aspect of the present disclosure includes, among other things, a first cell stack, a second cell stack, and a separator arranged between the first cell stack and the second cell stack. The separator includes a first hollow section that establishes a first air gap for inhibiting a transfer of thermal energy between the first cell stack and the second cell stack.

In a further non-limiting embodiment of the foregoing battery system, the first cell stack and the second cell stack each includes a plurality of battery cells and a plurality of cell expansion pads.

In a further non-limiting embodiment of either of the foregoing battery systems, the plurality of battery cells and the plurality of cell expansion pads extend laterally between a first bus bar module and a second bus bar module.

In a further non-limiting embodiment of any of the foregoing battery systems, the separator includes a second hollow section that establishes a second air gap for inhibiting the transfer of thermal energy between the first cell stack and the second cell stack.

In a further non-limiting embodiment of any of the foregoing battery systems, the separator includes a rib that separates the first air gap from the second air gap.

In a further non-limiting embodiment of any of the foregoing battery systems, the rib extends between a first side wall and a second side wall of the separator.

In a further non-limiting embodiment of any of the foregoing battery systems, the rib extends between a top wall and a bottom wall of the separator.

In a further non-limiting embodiment of any of the foregoing battery systems, the separator establishes a center wall of the battery system.

In a further non-limiting embodiment of any of the foregoing battery systems, the separator includes a first side wall that interfaces with the first cell stack, a second side wall that interfaces with the second cell stack, a top wall, and a bottom wall.

In a further non-limiting embodiment of any of the foregoing battery systems, a perimeter structure is joined to the top wall or the bottom wall.

In a further non-limiting embodiment of any of the foregoing battery systems, the perimeter structure is a top cover.

In a further non-limiting embodiment of any of the foregoing battery systems, the first side wall includes an indentation that establishes a vent channel between the separator and the first cell stack.

In a further non-limiting embodiment of any of the foregoing battery systems, the first side wall includes a cut-out, and a thermally insulative material is positioned within the cut-out.

In a further non-limiting embodiment of any of the foregoing battery systems, a thermal barrier sheet is arranged between the first cell stack and the first side wall of the separator.

In a further non-limiting embodiment of any of the foregoing battery systems, an opening is formed through the top wall or the bottom wall and is sized to receive a fastener for joining the separator to a perimeter structure.

A traction battery pack according to another exemplary aspect of the present disclosure includes, among other things, a first cell stack, a second cell stack, a separator arranged between the first cell stack and the second cell stack, and a perimeter structure joined to the separator.

In a further non-limiting embodiment of the foregoing traction battery pack, the perimeter structure is a top cover of an outer housing of a battery system that includes the first cell stack and the second cell stack.

In a further non-limiting embodiment of either of the foregoing traction battery packs, the perimeter structure is a top cover of an outer enclosure assembly of the traction battery pack.

In a further non-limiting embodiment of any of the foregoing traction battery packs, the separator includes an air gap for inhibiting a transfer of thermal energy between the first cell stack and the second cell stack.

In a further non-limiting embodiment of any of the foregoing traction battery packs, the separator includes a first side wall including an indentation that establishes a vent channel between the separator and the first cell stack.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 schematically illustrates an electrified vehicle.

FIG. 2 is a perspective view of an exemplary battery system of a traction battery pack. The battery system includes an exemplary separator arranged between adjacent cell stacks of the battery system.

FIG. 3 is a cross-sectional view through section 3-3 of FIG. 2.

FIG. 4 illustrates another exemplary battery system of a traction battery pack.

FIGS. 5A, 5B, and 5C schematically illustrate a separator of a battery system joined to a perimeter structure.

FIG. 6 illustrates another exemplary separator.

FIG. 7 illustrates another exemplary separator.

FIG. 8 illustrates another exemplary separator.

FIG. 9 illustrates another exemplary separator.

FIG. 10 illustrates another exemplary separator.

FIG. 11 illustrates another exemplary separator.

FIG. 12 illustrates yet another exemplary separator.

### DETAILED DESCRIPTION

This disclosure details battery systems for traction battery packs. An exemplary battery system may include a first cell stack, a second cell stack, and a separator arranged between the first and second cell stacks. The separator may be configured to mitigate the transfer of thermal energy from cell stack-to-cell stack, structurally integrate the battery system to perimeter structures, inhibit cell displacement due to external forces, resist cell expansion forces, etc. These and other features are discussed in greater detail in the following paragraphs of this detailed description.

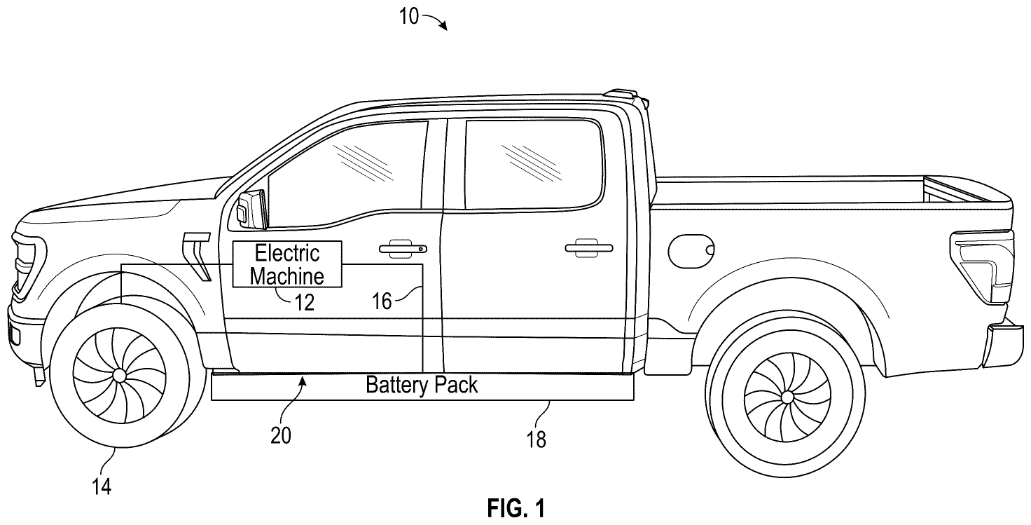

FIG. 1 schematically illustrates an electrified vehicle 10. The electrified vehicle 10 may include any type of electrified powertrain. In an embodiment, the electrified vehicle 10 is a battery electric vehicle (BEV). However, the concepts described herein are not limited to BEVs and could extend to other electrified vehicles, including, but not limited to, hybrid electric vehicles (HEVs), plug-in hybrid electric vehicles (PHEV's), fuel cell vehicles, etc. Therefore, although not specifically shown in the exemplary embodiment, the powertrain of the electrified vehicle 10 could be equipped with an internal combustion engine that can be employed either alone or in combination with other power sources to propel the electrified vehicle 10.

In the illustrated embodiment, the electrified vehicle 10 is depicted as a pickup truck. However, the electrified vehicle 10 could alternatively be a sedan, a sport utility vehicle (SUV), a van, or any other vehicle configuration. Although a specific component relationship is illustrated in the figures of this disclosure, the illustrations are not intended to limit this disclosure. The placement and orientation of the various components of the electrified vehicle 10 are shown schematically and could vary within the scope of this disclosure.

In an embodiment, the electrified vehicle 10 is a full electric vehicle propelled solely through electric power, such as by one or more electric machines 12, without any assistance from an internal combustion engine. The electric machine 12 may operate as an electric motor, an electric generator, or both. The electric machine 12 receives electrical power and can convert the electrical power to torque for driving one or more wheels 14 of the electrified vehicle 10.

A voltage bus 16 may electrically couple the electric machine 12 to a traction battery pack 18. The traction battery pack 18 is an exemplary electrified vehicle battery. The traction battery pack 18 may be a high voltage traction battery pack assembly that includes battery cell groupings capable of outputting electrical power to power the electric machine 12 and/or other electrical loads of the electrified vehicle 10. Other types of energy storage devices and/or output devices could alternatively or additionally be used to electrically power the electrified vehicle 10.

The traction battery pack 18 may be secured to an underbody 20 of the electrified vehicle 10. However, the traction battery pack 18 could be located elsewhere on the electrified vehicle 10 within the scope of this disclosure.

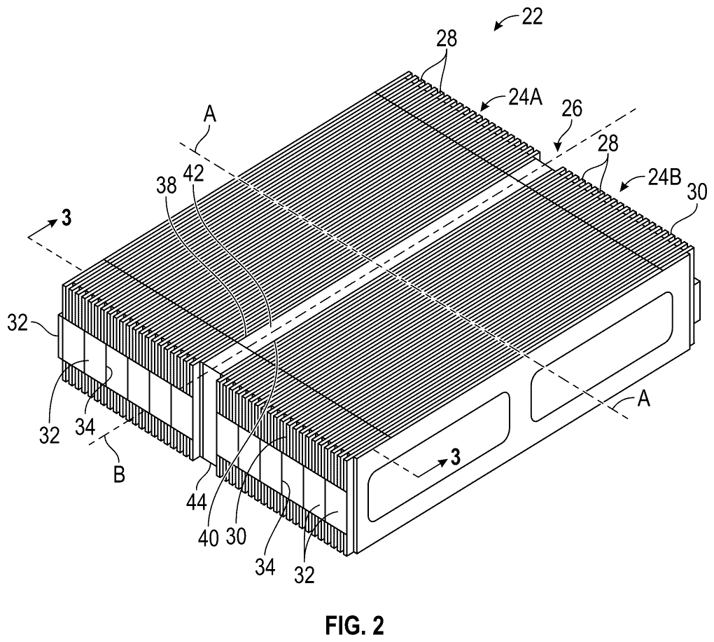

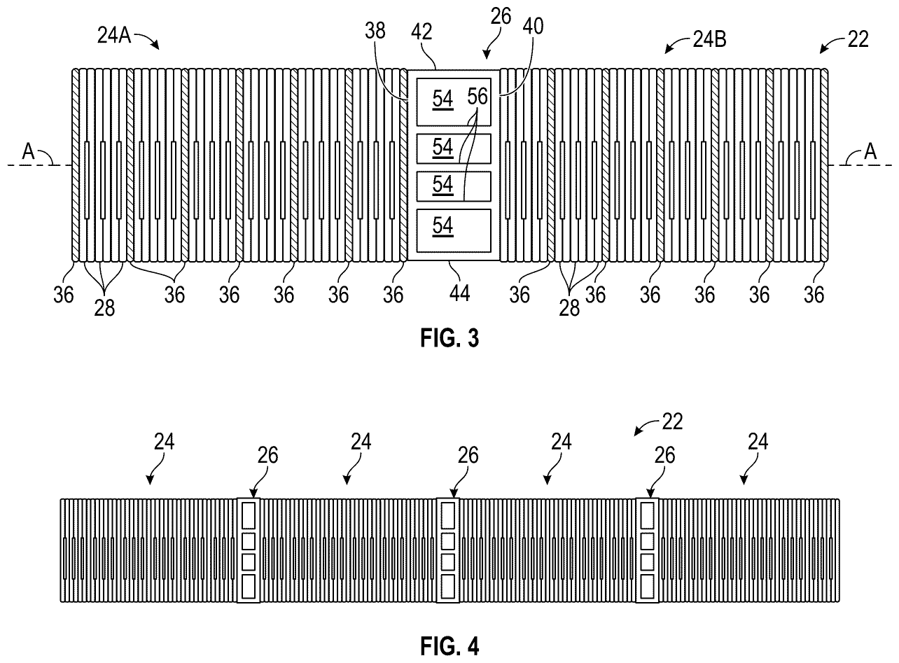

FIGS. 2 and 3 illustrate an exemplary battery system 22 for a traction battery pack, such as the traction battery pack 18 of FIG. 1, for example. The battery system 22 may include two or more cell stacks 24 and one or more separators 26. In the exemplary embodiment of FIGS. 2-3, the battery system 22 includes a first cell stack 24A, a second cell stack 24B, and a separator 26 arranged between the first cell stack 24A and the second cell stack 24B. However, other configurations are contemplated within the scope of this disclosure. For example, in another embodiment, the battery system 22 may include a plurality of cell stacks 24, with each adjacent pair of cell stacks 24 being separated by one separator 26 (see, e.g., FIG. 4). Accordingly, as would be appreciated by a person of ordinary skill in the art having the benefit of this disclosure, the battery system 22 could be designed to include any amount of cell stacks 24 and separators 26.

The first cell stack 24A and the second cell stack 24B may each include a plurality of battery cells 28. In an embodiment, the battery cells 28 are lithium-ion pouch cells. However, battery cells having other geometries (cylindrical, prismatic, etc.) and/or chemistries (nickel-metal hydride, lead-acid, etc.) could alternatively be utilized within the scope of this disclosure. The total number of battery cells 28 provided within each cell stack 24 of the battery system 22 could vary and is thus not intended to limit this disclosure.

The battery cells 28 of each of the first cell stack 24A and the second cell stack 24B may be stacked together along a respective stack axis A. In an embodiment, a longitudinal axis B (see FIG. 2) of the separator 26 is transverse (e.g., perpendicular) to the stack axes A. However, other configurations are possible.

The battery cells 28 of each of the first cell stack 24A and the second cell stack 24B may laterally extend between a pair of bus bar modules 30. Tab terminals 32 of the battery cells 28 may extend through slots 34 formed through the bus bar modules 30. Each bus bar module 30 may include a plurality of bus bars (not shown) that may be joined to the tab terminals 32 for electrically connecting the battery cells 28 to one another. Once electrically coupled, the battery cells 28 can supply electrical power necessary for achieving electric propulsion of the electrified vehicle 10.

A cell expansion pad 36 may be arranged between some neighboring battery cells 28 within each of the first cell stack 24A and the second cell stack 24B. The cell expansion pads 36 may include a material(s) (e.g., polyurethane foam, silicone foam, etc.) adapted for accommodating battery cell swelling. In an embodiment, groups of three individual battery cells 28 are separated by cell expansion pads 36 along the stack axis A of each cell stack 24A, 24B (see FIG. 3). However, other configurations are contemplated within the scope of this disclosure, and it should be apparent to those having the benefit of this disclosure that the first cell stack 24A and the second cell stack 24B could each include any number and arrangement of battery cells 28 and cell expansion pads 36.

The separator 26 may be an extruded metallic component of the battery system 22. For example, the separator 26 could be an extruded aluminum component. However, other materials, including rigid polymeric materials, and manufacturing techniques could alternatively or additionally be utilized to manufacture the separator within the scope of this disclosure.

In the illustrated embodiment, the separator 26 is positioned at or near the center of the battery system 22 and may therefore be considered to provide a center wall of the battery system 22. However, the separator 26 could be located elsewhere along the length of the battery system 22, such as when the battery system 22 includes greater than two cell stacks (see FIG. 4, for example). As further discussed below, the separator 26 may be a structural component of the battery system 22 that is configured to mitigate the transfer of thermal energy between the cell stacks 24, structurally integrate the battery system 22 to one or more perimeter structures, inhibit battery cell 28 displacement due to external forces, resist battery cell 28 expansion forces, etc.

The separator 26 may include may include a first side wall 38 and a second side wall 40 that is spaced apart from the first side wall 38. When the separator 26 is arranged within the battery system 22, the first side wall 38 faces toward and can interface with the first cell stack 24A, and the second side wall 40 faces toward and can interface with the second cell stack 24B. The first side wall 38 may be adhesively secured to the first cell stack 24A and the second side wall 40 may be adhesively secured to the second cell stack 24B to structurally integrate the battery system 22.

The separator 26 may additionally include a top wall 42 and a bottom wall 44. The top wall 42 and the bottom wall 44 may connect between the first side wall 38 and the second side wall 40 at opposite ends of the separator 26.

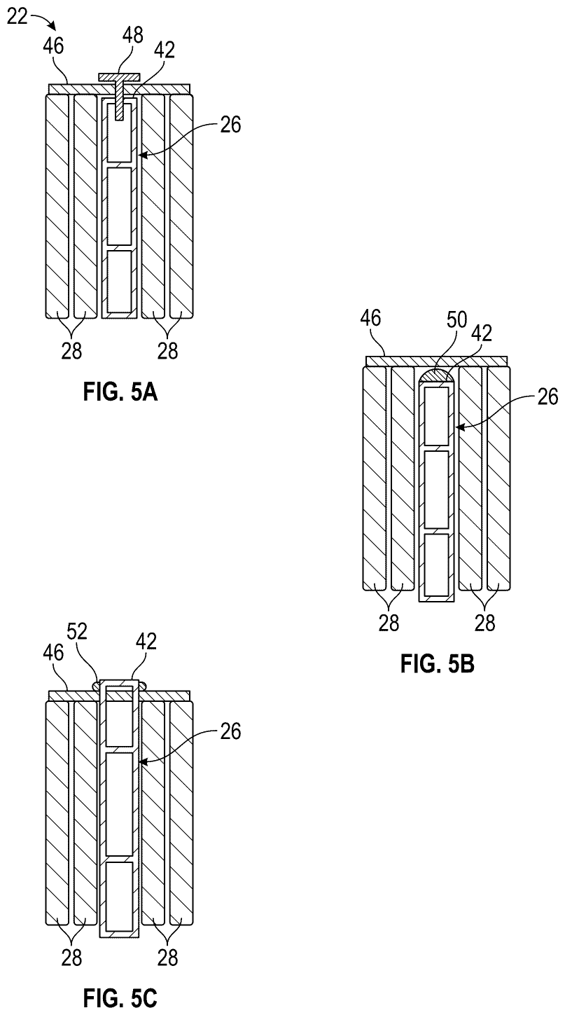

The top wall 42 may interface with a top cover 46 (see, e.g., FIGS. 5A-5C). The top cover 46 could be part of either an outer housing of the battery system 22 or an outer enclosure assembly of the traction battery pack 18. The top wall 42 of the separator 26 may be joined to the top cover 46 by a mechanical fastener 48 (see FIG. 5A), a high-temperature adhesive 50 (see FIG. 5B), or a weld 52 (see FIG. 5C).

Once the separator 26 and the top cover 46 are joined together, these structures are effectively structurally coupled to one another for increasing the structural stiffness of the battery system 22 and inhibiting battery cell displacement that could be caused by external forces acting on the battery system 22. Further, once joined to the top cover 46 (or some other perimeter structure), the separator 26 can substantially prevent thermal energy from moving from one cell stack 24 to another at the interface between the separator 26 and the top cover 46, such as during a battery thermal event in which one or more battery cells 28 of either the first cell stack 24A or the second cell stack 24B release vent gases or other vent byproducts, for example. The separator 26 may therefore function to separate and thermally isolate the first and second cell stacks 24A, 24B from one another.

One or more hollow channels 54 may be formed through the separator 26. The hollow channels 54 may extend between the first side wall 38 and the second side wall 40 and may extend across an entire length of the separator 26 along the direction of the longitudinal axis B.

Each hollow channel 54 may establish an air gap inside the separator 26. The air gaps increase the thermal resistance and slow heat transfer between the neighboring cell stacks 24 of the battery system 22. The battery system 22 may therefore be capable of maintaining emitted energy below a critical level at which the thermal mass of the traction battery pack 18 can no longer compensate while also reducing manufacturing/design complexities.

Adjacent hollow channels 54 of the separator 26 may be separated from one another by a rib 56. In the illustrated embodiment of FIG. 3, the separator 26 includes four hollow channels 54 and three ribs 56. However, other configurations are contemplated within the scope of this disclosure, and therefore it should be understood that the separator 26 could include any amount of the hollow channels 54 and the ribs 56.

Each rib 56 may extend inside the separator 26 and is thus an internal component of the separator 26. Each rib 56 may connect between the first side wall 38 and the second side wall 40 for increasing the structural stiffness of the separator 26. The ribs 56 may additionally function to reduce convection across the separator 26 by limiting the circulation of airflow between adjacent hollow channels 54.

Notably, the first cell stack 24A and the second cell stack 24B can be constructed without the use of traditional thermal barriers that are often made with complex designs and relatively expensive materials (e.g., mica, aerogel, etc.) and typically arranged between adjacent groups of battery cells for mitigating heat transfer across each respective cell stack 24. Eliminating these types of traditional thermal barriers frees up a relatively significant amount of space and reduces assembly expenses and complexities associated with the battery system 22. The separator 26 may be positioned at any desired location of the battery system 22 by virtue of the open space created by eliminating traditional thermal barriers from the cell stacks 24.

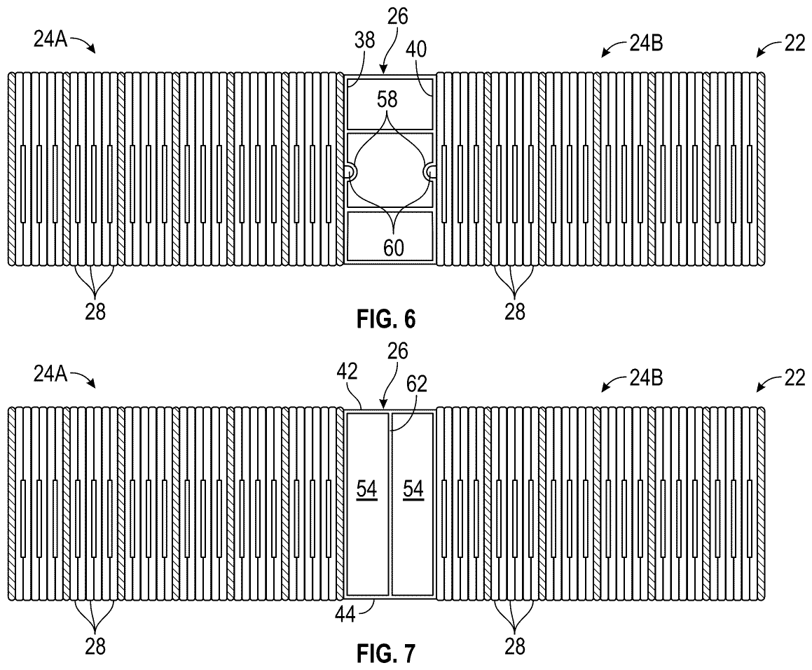

Referring now to FIG. 6, one or more indentations 58 may be formed in each of the first side wall 38 and the second side wall 40 of the separator 26. The indentations may establish vent channels 60 between the cell stacks 24 and the separator 26 that provide a venting path for expelling vent gases released by one or more battery cells 28 of the battery system 22 during a battery thermal event. For example, from time to time, pressure and thermal energy within at least one of the battery cells 28 can increase. This can lead to the battery cell 28 discharging a flow of the vent byproducts, which can include gas and debris. The vent byproducts can be discharged from the battery cell 28 through a designated cell vent within a housing of the battery cell 28 through a membrane that yields in response to increased pressure and thermal energy within the battery cell 28. The cell vent could also be a ruptured area of the associated battery cell 28.

When one or more battery cells 28 vent in the above manner, the vent byproducts can flow toward the separator 26 and then enter the vent channels 60. Upon entering the vent channels 60, the vent byproducts can flow longitudinally across the length of the vent channels 60 prior to being expelled from the battery system 22. The vent channels 60 therefore allow the vent byproducts to be funneled in a desired direction to facilitate vent gas management.

Alternatively or additionally, as shown in FIG. 7, the hollow channels 54 may be configured as vent channels for receiving and expelling the vent byproducts from the battery system 22. In such an implementation, a dividing wall 62 may be positioned within the separator 26 for separating adjacent hollow channels 54 from one another and for limiting convective heat transfer therebetween. The dividing wall 62 may extend between the top wall 42 and the bottom wall 44 of the separator 26.

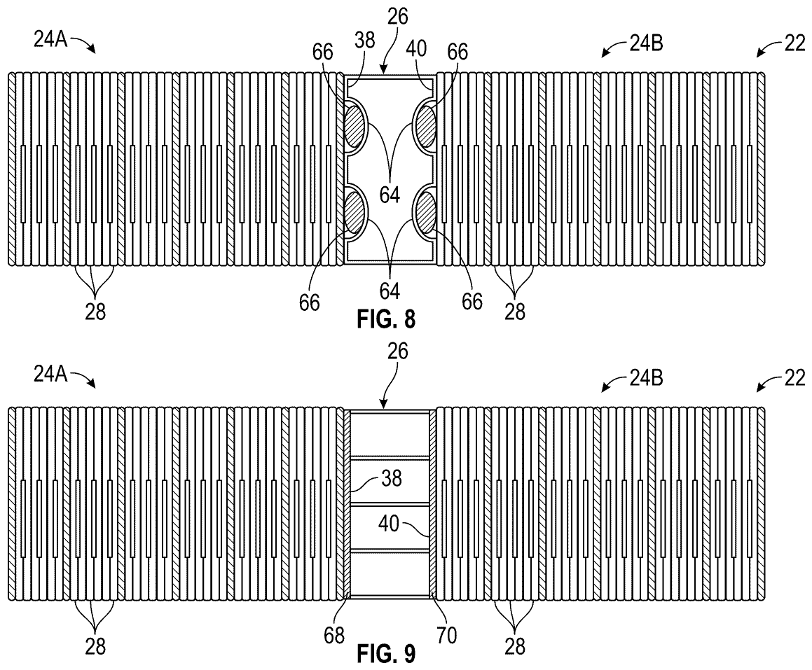

Referring to FIG. 8, one or more cut-outs 64 may be provided in each of the first side wall 38 and the second side wall 40 of the separator 26. A thermally insulative material 66 may be positioned within each of the cut-outs 64. The thermally insulative material 66 may be configured to expand when exposed to temperatures that exceed a predefined temperature threshold to further mitigate the transfer of thermal energy between adjacent cell stacks 24 of the battery system 22. Expansion of the thermally insulating material 66 can create a seal for trapping vent byproducts and thereby limiting their thermal influence on downstream components of the battery system 22.

The thermally insulative material 66 may be an aerogel, a silicone gel, a silicone foam, etc. However, other materials or combinations of thermally insulative materials could be utilized in combination with the separator 26 within the scope of this disclosure.

Referring to FIG. 9, a first thermal barrier sheet 68 may be arranged between the first cell stack 24A and the first side wall 38 of the separator 26, and a second thermal barrier sheet 70 may be arranged between the second cell stack 24B and the second side wall 40 of the separator 26. The first and second thermal barrier sheets 68, 70 may be configured to further inhibit the transfer of thermal energy across the separator 26.

In an embodiment, the first and second thermal barrier sheets 68, 70 are mica sheets. However, other types of thermal barriers are contemplated within the scope of this disclosure.

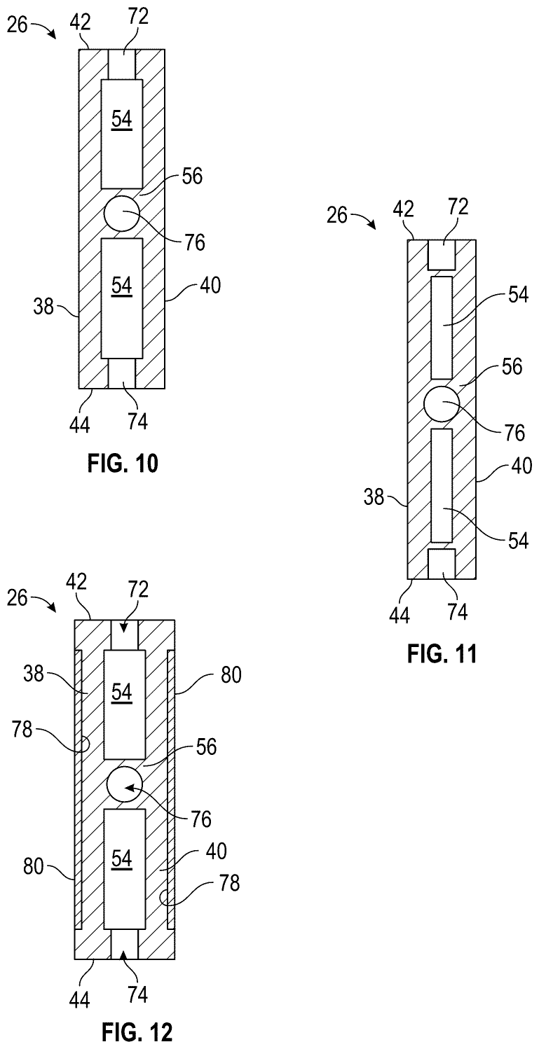

Referring to FIG. 10, various openings may be formed in the separator 26 for securing the separator to perimeter structures of the battery system 22 and/or the traction battery pack 18. In an exemplary embodiment, a first opening 72 may be formed through the top wall 42 of the separator 26, a second opening 74 may be formed through the bottom wall 44 of the separator 26, and a third opening 76 may be formed in one of the ribs 56 of the separator 26. The first opening 72 may be configured to receive a bolt or other fastener for securing the separator 26 to a top cover of an outer housing of the battery system 22 or an outer enclosure assembly of the traction battery pack 18, the second opening 74 may be configured to receive a bolt or other fastener for securing the separator 26 to a bottom cover of the outer housing of the battery system 22 or the outer enclosure assembly of the traction battery pack 18, and the third opening 76 may be configured to receive a bolt or other fastener for securing the separator 26 to an end plate of the battery system 22 or the traction battery pack 18.

In an embodiment, a diameter of the third opening 76 is smaller than a width of the hollow channels 54 (see FIG. 10). In another embodiment, the diameter of the third opening 76 is larger than the width of the hollow channels 54 (see FIG. 11).

In yet another embodiment, the first side wall 38 and the second side wall 40 of the separator 26 may each include a pocket 78 sized for receiving a foam sheet 80 (see FIG. 12). The foam sheets 80 may be configured for accommodating expansion forces caused by battery cell swelling within the cell stacks 24.

Notably, the various figures accompanying this disclosure are not necessarily drawn to scale. For example, features associated with the separator 26 may have been exaggerated in some images to better emphasize certain details associated with this component.

The exemplary battery systems of this disclosure include separators arranged to establish a barrier dam between adjacent cell stacks of the system. The separators function to inhibit the transfer of thermal energy between cell stacks and provide structural rigidity to the battery system without requiring the use of traditional thermal barriers.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A battery system for a traction battery pack, comprising:
a first cell stack;
a second cell stack; and
a separator arranged between the first cell stack and the second cell stack,
wherein the separator includes a first hollow section that establishes a first air gap for inhibiting a transfer of thermal energy between the first cell stack and the second cell stack.

2. The battery system as recited in claim 1, wherein the first cell stack and the second cell stack each includes a plurality of battery cells and a plurality of cell expansion pads.

3. The battery system as recited in claim 2, wherein the plurality of battery cells and the plurality of cell expansion pads extend laterally between a first bus bar module and a second bus bar module.

4. The battery system as recited in claim 1, wherein the separator includes a second hollow section that establishes a second air gap for inhibiting the transfer of thermal energy between the first cell stack and the second cell stack.

5. The battery system as recited in claim 4, wherein the separator includes a rib that separates the first air gap from the second air gap.

6. The battery system as recited in claim 5, wherein the rib extends between a first side wall and a second side wall of the separator.

7. The battery system as recited in claim 5, wherein the rib extends between a top wall and a bottom wall of the separator.

8. The battery system as recited in claim 1, wherein the separator establishes a center wall of the battery system.

9. The battery system as recited in claim 1, wherein the separator includes a first side wall that interfaces with the first cell stack, a second side wall that interfaces with the second cell stack, a top wall, and a bottom wall.

10. The battery system as recited in claim 9, comprising a perimeter structure joined to the top wall or the bottom wall.

11. The battery system as recited in claim 10, wherein the perimeter structure is a top cover.

12. The battery system as recited in claim 9, wherein the first side wall includes an indentation that establishes a vent channel between the separator and the first cell stack.

13. The battery system as recited in claim 9, wherein the first side wall includes a cut-out, and comprising a thermally insulative material positioned within the cut-out.

14. The battery system as recited in claim 9, comprising a thermal barrier sheet arranged between the first cell stack and the first side wall of the separator.

15. The battery system as recited in claim 9, comprising an opening formed through the top wall or the bottom wall and sized to receive a fastener for joining the separator to a perimeter structure.

16. A traction battery pack, comprising:
a first cell stack;
a second cell stack;
a separator arranged between the first cell stack and the second cell stack; and
a perimeter structure joined to the separator.

17. £ The traction battery pack as recited in claim 16, wherein the perimeter structure is a top cover of an outer housing of a battery system comprising the first cell stack and the second cell stack.

18. The traction battery pack as recited in claim 16, wherein the perimeter structure is a top cover of an outer enclosure assembly of the traction battery pack.

19. The traction battery pack as recited in claim 16, wherein the separator includes an air gap for inhibiting a transfer of thermal energy between the first cell stack and the second cell stack.

20. The traction battery pack as recited in claim 16, wherein the separator includes a first side wall including an indentation that establishes a vent channel between the separator and the first cell stack.
